(19) United States
(12) Patent Application Publication
(10) Pub. No.: US 2010/0146120 A1
(43) Pub. Date: Jun. 10, 2010

(54) CALLER-SPECIFIC VISIBILITY MASKS FOR NETWORKING OBJECTS

(75) Inventors: Dmitry A. Anipko, Bellevue, WA (US); David G. Thaler, Redmond, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: MICROSOFT CORPORATION, Redmond, WA (US)

(21) Appl. No.: 12/330,978

(22) Filed: Dec. 9, 2008

(51) Int. Cl. G06F 15/173; G06K 19/00

(52) U.S. Cl. 709/226; 726/4

(57) ABSTRACT

A computer configured to provide caller-specific network views, even when multiple callers are active on the computer. The operating system of the computer is configured to selectively perform network operations based on the identity of the caller. Network views are implemented by making subsets of networking objects available to each caller, such as a user or an application. Components that execute networking functions can, based on the identify of the caller, select networking objects to use in performing a requested function or verify that required networking objects are available to the caller. The network views may be stored as visibility masks in a database. APIs may be provided to create, modify, and delete visibility masks in the database. The masks may support arbitrary and potentially overlapping subsets of networking objects for the callers.

### BACKGROUND

Computer networks are frequently used to interconnect a group of computers. In some cases, multiple entities, such as users and applications, access a network through a single computer. Access may be initiated from terminals connected directly to the computer or via terminals connected over a secondary network. Supporting network access through a single computer may be done for cost savings, user convenience, or any of a number of reasons. Though such a computer could be configured with dedicated hardware to be used by each entity to access a network, some computers are configured so that the entities may share network hardware.

Various management approaches have been implemented by terminal servers to manage access to the network for multiple entities. In one approach, called virtualization, network interfaces are simulated for each entity. Each entity is associated with its own virtual network interface and unique set of network resources. Network resources are completely partitioned among the entities. Thus the terminal server configures the computer to operate as a switch directing incoming packets to the correspondingly addressed virtual network interface.

In another approach each entity is assigned a unique IP address and the hardware may process messages addressed to all entities in the computer.

In yet another approach, terminal servers have been designed to coordinate shared access for multiple users to a network through shared network hardware. The network resources are completely shared among the users. A terminal server can also introduce software for filtering, scanning, and analyzing received network traffic within the network protocol stack. One such example software is a Layered Service Provider (LSP) using the Microsoft Windows® operating system Winsock 2 component. An LSP can intercept and route messages between the network and applications that are accessing the network. LSPs have been used by computer security programs to analyze traffic for viruses, implement parental controls, and content filtering.

### SUMMARY

In a typical computer supporting network access, all local network resources such as network interfaces and IP addresses are available to all callers. The inventors have appreciated that it is desirable to provide an improved approach for allowing multiple entities (referred to as “callers”) to access a network. By configuring a computer supporting network access to provide finer grain access to network resources on a caller-by-caller basis, the behavior of the computer as it executes networking functions may more readily align with user expectations.

Such finer grained access may be established by associating with each caller one or more networking objects. Networking objects may be associated uniquely or shared by callers in any suitable way, allowing arbitrary relationships between networking objects and callers, even, for example, partially overlapping subsets available to different callers. As networking functions are called, the networking objects available to the caller, hereafter referred to as a “network view”, are ascertained, and those objects are used in responding to the request for the networking function. In some embodiments, the network view also prevents networking objects unavailable to a caller from being seen. For example, when an operation needs to pick a resource to use (such as, for example, when the caller did not specify one), the operation will pick one that will succeed, rather than just picking one and finding out later that it fails due to access denied.

In some embodiments, the network view is defined by a visibility mask, which may be maintained in a visibility mask database. The visibility mask associates a caller with one or more networking objects used to perform networking functions requested by the caller. Components executing networking functions may access the database to determine the networking objects available to the caller of the networking function. A masking programming interface may be provided such that components managing network views can modify the visibility mask database.

Caller-by-caller access to networking objects may be used to control execution of networking functions regardless of whether those functions result in commands being executed by or status being reported by networking components. A networking programming interface receives requests from a caller to perform a networking function and determines the available networking objects for the caller through the visibility mask database. The networking objects may be used in executing the function or to determine whether the caller has access necessary to complete the requested networking function. Though, the view may be used in other ways, such as to identify network status information relevant to the caller based on the caller's view.

In some aspects, the invention relates to a method of operating a computer device having access to a network. The method comprises receiving, from a caller, a call to perform a networking function; selecting a visibility mask based on an identity of the caller; determining an availability of one or more networking objects to the caller based on the visibility mask; and providing a response to the caller, the response being based at least in part on the networking function and the availability of the networking objects.

In another aspect, the invention relates to a computing device for managing access to a network. The computing device comprises a computer-storage medium and a processor. In some embodiments, the computer storage medium is configured to store a visibility mask database, the visibility mask database comprising a visibility mask associated with a caller. The processor is configured to, in response to a call from the caller to perform a networking function, access the visibility mask database to determine an availability of a networking object to the caller based on the visibility mask and respond to the caller, the response being based at least in part on the networking function and the availability of the networking object.

In yet another aspect, the invention relates to a computer-storage medium comprising computer executable modules, the modules comprising a masking programming interface and a networking programming interface. The masking programming interface is configured to manage a visibility mask database having a plurality of visibility masks. In some embodiments, each visibility mask associates a caller with a networking object. The networking programming interface is configured to, when invoked by a caller, access a visibility mask from the visibility mask database, the visibility mask being associated with the caller, and respond to the caller based at least in part on a networking object identified in the visibility mask as available to the caller.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is an example of an environment in which some embodiments of the invention may operate, here illustrated as a terminal server environment;

FIG. 2 is a block diagram of a computer device running a terminal server according to some embodiments;

FIG. 3 is a diagram of a visibility mask database according to some embodiments;

FIG. 4 illustrates a method of managing access to a network and related resources according to some embodiments; and

FIG. 5 illustrates a method of managing access to a network and related resources according to some embodiments.

### DETAILED DESCRIPTION

The inventors have recognized and appreciated that both user experience and programming experience can be improved in a networked computer system that supports multiple entities calling networking functions. The computer system can be configured to support network views per caller. Whenever a networking function is requested, an appropriate network view may be applied so that the function is performed as intended for the caller.

In contrast to prior systems in which resources are either completely partitioned among the callers (one resource per caller) or are completely shared among the callers (accessible to all callers), a system that supports network views may allow arbitrary subsets of resources to be defined and made available to any given caller.

In some embodiments, components that implement network views per caller are contained within operating system components. As a result, even applications that have not been specially coded for execution on a computer that supports multiple callers can provide consistent execution even when other callers are invoking networking functions that would otherwise interfere with execution of the application.

In some embodiments, a “caller” may be a user of a computing device, such that different users have different network views. However, a caller may be any identifiable entity, including individual entities, classes of entities or groups of entities. For example, a caller may be an application or a specific instance of an application. In some embodiments, callers may be uniquely identified to provide additional security and further prevent unintended or malicious use of a caller's network view.

Though a network view may be implemented in any suitable way, in some embodiments, a network view determines the networking objects available to a caller. A networking object may be any representation that can be manipulated by a computer of information used in performing networking functions. This information may be stored in computer storage media in the computer as a data structure and/or as computer-executable instructions or in any other suitable way.

A network view may not only determine the networking objects available to a caller, it may also control whether networking objects unavailable to the caller are visible to the caller. Specifically a network view may determine if an object “can be seen” but the caller gets access denied trying to use it, or “cannot be seen.” Firewall rules today can do the former but not the latter. In some embodiments, a network view may do the latter. For example, when an operation needs to pick a resource to use (such as, for example, when the caller did not specify one), only resources to which the caller may be granted access are visible. As a result, the operation will pick one that will succeed, rather than just picking one and finding out later that it fails due to access denied.

The types of networking objects may depend on networking protocols in use on a computer system and the network. In a computer interfaced to a network using an IP protocol, networking objects may include Internet Protocol (IP) addresses, IP routes, and IP interfaces. Though, different or additional networking objects may be used.

In some embodiments, each networking object may relate to a parameter of a physical networking interface. Though, other embodiments are possible, and in some embodiments, the networking objects may relate to virtual network interfaces.

Network views may be implemented by associating networking objects with callers as networking functions are requested by those callers. The selected networking objects may be used in responding to the requested function.

Any suitable mechanism may be used to define a network view for a caller. A visibility mask, which may be a data structure and/or program or other mechanism that associates network views with callers, may be used. A visibility mask, for example, may define networking objects available to a caller.

When a caller requests performance of a networking function, the network view for that caller may be determined from the visibility mask. A networking application programming interface (API) or other component implementing the networking function may apply a visibility mask for each caller.

The improved approach, for example, may be used in a computer in which multiple callers share the same networking hardware. It should be appreciated that some existing systems may easily be modified to support caller-specific network views. Conventional networking APIs may be modified or replaced with networking APIs that consult a visibility masks database and enforce caller-specific network views. In some embodiments, replacing the networking APIs may only require updating the implementation and may not require changing the API signatures so that software applications accessing networking functions using those APIs may readily be used with a computer system modified to support caller-specific network views as described herein.

In an illustrative embodiment, the improved approach may be used in a computer configured to act as a terminal server allowing multiple users to access a network through a shared network interface such as a network interface card and associated driver software. However, the improved approach may be employed to manage network access for other types of callers in other environments.

Embodiments of the invention may be implemented for callers of different types. For example, embodiments of the invention may be implemented in which users or user sessions are regarded as callers. In such embodiments, all applications being run by a user may have the same network view. In other embodiments, applications may be regarded as callers, and all instances of the application, regardless of which user invokes them, may have the same network view. In yet other embodiments, the caller of a networking function may be a specific application instance. Accordingly, the granularity with which network views are administered is not critical to the invention, and any level or levels of granularity at which callers may be identified may be used to establish network views.

User accounts, user sessions, and instances of applications, processes, or threads are all potential examples of callers. What entities are identifiable may be system specific. For example, in some computer systems an operating system determines which entities are identifiable. Some operating systems, for example, may identify user accounts and sessions but not applications. Accordingly, callers may exist at any suitable level of granularity.

In some embodiments of an appropriately configured system, each of the users, sessions, and applications are uniquely identifiable entities. These uniquely identifiable entities may have a clear hierarchical structure and accompanying granularity. The user account, having the coarsest granularity, may be hierarchically superior to the one or more sessions. The sessions have a moderate granularity and are hierarchically superior to one or more applications, the applications thus having the finest granularity in this example.

As an example, in some embodiments, a terminal server operating on a computing device may manage a physical network connection to allow multiple users access to a network. In such an embodiment, the users may be regarded as the callers of networking functions. Improvements may be made by providing network views to each user, for example allowing each user to use a separate IP address on the same physical network connection.

In a conventional terminal server environment, problems can arise if one user attempts to perform networking functions that interfere with networking functions to be performed by another user. For example, some legacy applications observe data communications on a specific port. When this port is in use by one application, another user running a second instance of the same application may attempt to access the network on the same port, creating a conflict. Such conflicts may be prevented, for example, by associating callers with unique network views and selecting communication parameters such as IP address for each instance of the application based on the network view of the user invoking the instance.

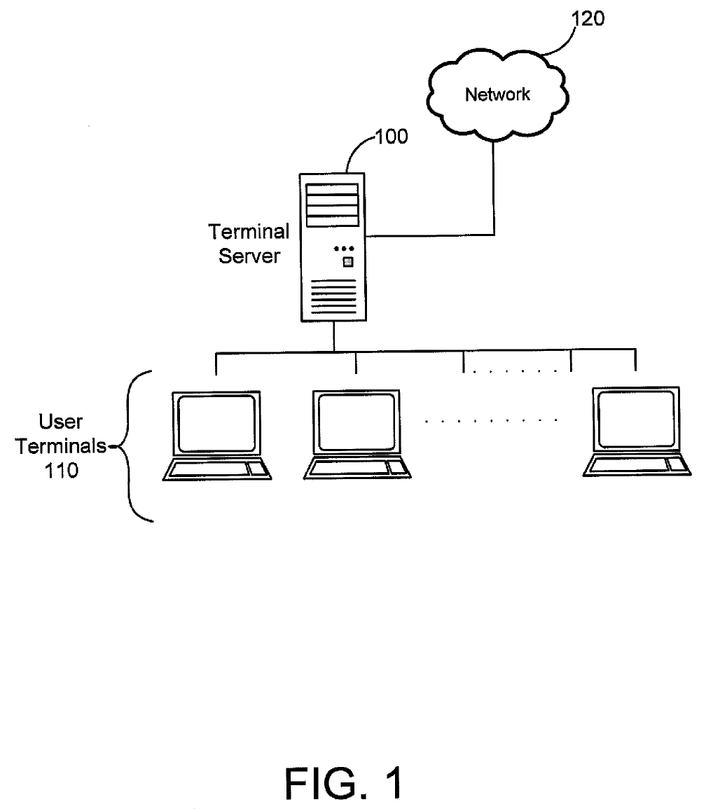

An embodiment of a terminal server environment is shown in FIG. 1. In FIG. 1, computing device 100 is configured to run as a terminal server. Computing device 100 may be a computer server, personal computer, router, or any type of suitably configured computing equipment. The terminal server may be implemented as one or more software modules using known programming techniques. In some embodiments, the software modules implementing a terminal server may be components of the operating system of the computer. Though, the computing device may have an operating system separate from the terminal server. In addition, computing device 100 may support user applications or other software modules in addition to the terminal server.

The terminal server provides users of user terminals 110 access to a network 120 through one or more shared physical network connections. Users of the user terminals 110 may be identified in any suitable way. As one example, user login accounts may be used to obtain credentials that enable access to terminal server services. The user accounts provide a mechanism to identify an entity and thus may be the basis to identify callers in the present example.

User terminals 110 provide an entry point for multiple users to interact with the terminal server. User terminals 110 may be physical devices and may take the form of any suitable computing device such as thin-clients, IP phones, personal computers, and the like. If physical devices, user terminals 110 may be proximal to the computing device 100 or located remotely. In some embodiments, user terminals may be directly integrated into computing device 100. Some embodiments of computing device 100 may support any combination of remote, proximal, and integrated user terminals. User terminals 110 may be connected to the computing device 100 in any suitable way. User terminals may be hard-wired to the terminal server. User terminals may be connected over secondary wired and/or wireless networks. The terminal server may permit any suitable number of user terminals to be connected simultaneously.

Though, it is not necessary that the user terminals be physical devices. User terminals may be created through different login sessions on a computing device that has a single user interface. Thus, the mechanism by which multiple users may gain access to a computing device is not a limitation on the invention.

The type of networking functions performed by a computing device incorporating per-caller network views also is not a limitation on the invention. Network 120 may be any type of network. Examples of suitable networks include Personal Area Network (PAN), Local Area Network (LAN), Campus Area Network (CAN), Metropolitan Area Network (MAN), Wide Area Network (WAN), Global Area Network (GAN), and the like. The network 120 may provide access to any of the Internet, an extranet, an intranet, and the like.

Any suitable communications protocol may be used by network 120. For example, the network 120 may support any of IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Protocol), SSH (Secure Shell Protocol), POP3 (Post Office Protocol 3), SMTP (Simple Mail Transfer Protocol), IMAP (Internet Message Access Protocol), and the like.

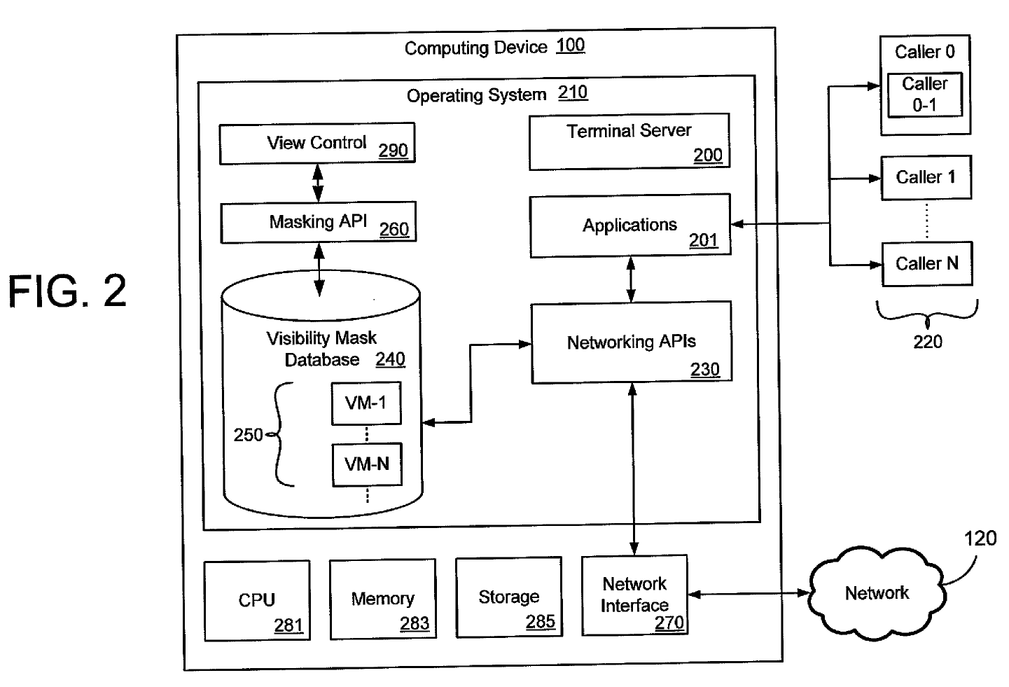

FIG. 2 illustrates an implementation of computing device 100 that may support a multi-caller environment as illustrated in FIG. 1. The computing device 100 is made of any suitable combination of computer hardware and computer software. The computing device 100 may include computer hardware such as a processor 281, memory 283, and storage device 285. Processor 281, memory 283, and storage device 285 and other hardware components may be operably coupled to exchange information, for example, using a bus.

Processor 281 may be any suitable processor for executing computer executable code. For example, processor 281 may be a central processing unit (CPU), microprocessor, microcontroller, and the like. Though FIG. 2 shows only one CPU, a computer may contain multiple CPUs of the same type and/or different types.

Memory 283 may be any suitable form of computer memory. Computer memory includes, but is not limited to, RAM, ROM, EEPROM, flash memory, or any other suitable memory technology.

Storage device 285 may be any suitable computer storage media. Computer storage media includes, but is not limited to magnetic storage devices, optical storage devices, other types of volatile and non-volatile memory, any other medium which may be used to store information and/or computer-executable instructions and which can be accessed by a computer. Though FIG. 2 shows only one computer storage component, a computer may contain multiple types of computer storage media.

Computing device 100 may include one or more network interfaces 270. Network interface 270 may be any suitable combination of hardware and software configured to access network 120. For example, network interface 270 may be implemented as a network interface driver and a network interface card (NIC). The network interface driver may be configured to receive instructions from other components of computing device 100 to perform operations with the NIC. The NIC provides a physical connection to network 120. The NIC is configured to generate and receive signals for communication over network 120.

Computing device 100 may include computer executable software modules. The software modules may be stored in memory 283 and/or storage device 285, and executed by processor 281, though this is just an illustrative embodiment and other storage locations and executions means are possible. In some embodiments, the operating system 210, terminal server 200, applications 201, networking APIs 230, visibility mask database 240, masking API 260, and a network view controller 290, which is representative of any of a number of possible sources of control information to define network views (as described in more detail below), may be implemented as computer executable modules. However, these components may be implemented using any suitable combination of hardware and/or software.

OS 210 may provide functions for applications executing on computer 100. In addition, OS 210 may manage the activities and sharing of resources of computing device 100. The OS 210 may implement management through various components, only some of which are illustrated in FIG. 2 for simplicity. In some embodiments, at least some of terminal server 200, applications 201, networking APIs 230, visibility mask database 240, masking API 260, and network view controller 290 are implemented as computer-executable components of OS 210.

As described above in connection with FIG. 1, terminal server 200 interfaces with multiple users, allowing the users to communicate over network 120. In this embodiment, each of the users may be a caller, which are depicted in FIG. 2 as callers 220. In the embodiment illustrated, terminal server 200 may enable one or more callers to interact with applications 201 on computer 100. The callers may interact directly with any number of applications 201 running on the computing device 100. Applications 201 may be any suitable type of software that may interface with one or more callers. When an application 201 receives a request from a caller 220 requesting performance of a networking function, that request may be directed to networking APIs 230.

Here networking APIs 230 represent interfaces to computer executable code that, when executed, performs networking functions. A networking function, for example, could configure network interface 270 or provide status on network interface 270. As another example, a networking function could trigger the transmission of data over the network. Such networking functions are known and are implemented within the networking stack in conventional computer systems. Though, networking functions may be implemented in other components within a computer system. For example, components within an operating system that implement remote procedure calls may also support networking functions. Accordingly, the specific networking functions supported and the manner in which they are implemented are not limitations on the invention.

Any suitable components, whether now known or hereafter developed, may be used to construct computer 100. In some embodiments, components of computer 100 may be constructed using techniques as are known in the art. For example, CPU 281, memory 283, storage 285, network interface 270 and terminal server 200 may be as in conventional computer systems.

Operating system (OS) 210 may also be constructed using techniques as are known in the art. However, in the embodiment illustrated in FIG. 2, the OS is modified relative to a conventional OS to support network views per caller.

Operating system 210 may, in contrast to a conventional operating system, contain a store of information that may be used to implement network views on a caller-by caller basis. In the example of FIG. 2, visibility mask database 240 may be used to store such information. In the example embodiment, such information is stored as visibility masks 250. Though, any suitable organization of information may be used.

The components that implement networking functions, which are here represented by networking APIs 230, may also be implemented using known techniques, though modified to operate in accordance with a network view associated with a caller invoking the networking function.

In the example, of FIG. 2, networking APIs 230 receive requests from the applications 201 to perform networking functions on behalf of callers 220. When a call is directed to networking APIs 230 from an application 201, the networking APIs initially identify the caller. Known interfaces between components in a computer system include information that identifies the caller that issued the request. Networking APIs 230 may incorporate such mechanisms such that a caller can be identified for each networking function requested. Though, any suitable mechanism, whether now known or hereafter developed, may be used for caller identification.

Regardless of the mechanism by which the caller is identified, once the caller has been identified, the networking APIs 230 may access the visibility mask database 240 to determine the caller's network view from the visibility mask associated with the caller. This network view may be used in performance of the requested function.

The specific manner in which the network view is used may depend on the requested function. For example, if the function requires access to networking objects, the networking API may determine if the requested networking function can be performed using networking objects available to the caller. For example, the networking function may request transmission of data over the network 120 using a specific IP address. If that IP address is available to the caller, the networking function may proceed. For example, the called networking API may instruct the network interface 270 to transmit the data using the requested IP address. On the other hand, if the caller does not have access to the requisite networking objects the networking APIs may not be able to complete the request and the networking function may fail.

Though, the network view may be used in other ways to respond to a networking request. As another example, a request for execution of a networking function may not specify any IP address to use in completing a function. In this case, the called API may access visibility mask database 240 to choose an IP address available to the caller.

Another example of a networking function is a network status request. A network status request may be a request to report the status of some parameter associated with networking interface 270, but the relevant information may be different for different network views. In this example, the networking APIs 230 may access the visibility mask database as above and may report status of a parameter identified based on the network view of the caller.

Thus, it should be appreciated that the networking APIs may support any networking functionality, whether now known or hereafter developed.

Any suitable mechanism may be used to define network views associated with callers. In the embodiment illustrated in FIG. 2, visibility mask database 240 may be managed by a network view controller 290. Network view controller 290 may use any suitable method for assigning network views through visibility masks to callers 220. For example, network view controller 290 may provide a user interface to an administrative user of computer 100. In this embodiment, visibility mask database 240 may be configured by an administrator.

Though, other mechanisms for specifying network views for callers may be employed instead of or in addition to input by an administrator. For example, the network view controller 290 may be implemented as a part of OS 210 enabling the terminal server or other OS component to configure network views. As another example, network view controller 290 may provide one or more programming interfaces. As application programs are installed, they could, for example, set network views.

Thus, it should be appreciated that network view controller 290 is representative of any of a number of possible sources of control information and the method by which network views are defined is not a limitation on the invention. Also, it should be appreciated that the timing at which visibility masks are managed is not critical to the invention. Visibility masks may be created, modified, and deleted by the visibility mask controller 290 at any suitable time, for example, when a user logs in or logs off, at the opening or closing of a session, or the starting and stopping of an application.

Regardless of the manner in which network views are defined, masking API 260 may be provided to create, modify, delete or otherwise administer visibility masks 250 in the visibility mask database 240. Though any suitable implementation may be used, each such interface may be implemented as computer-executable instructions that perform a requested function.

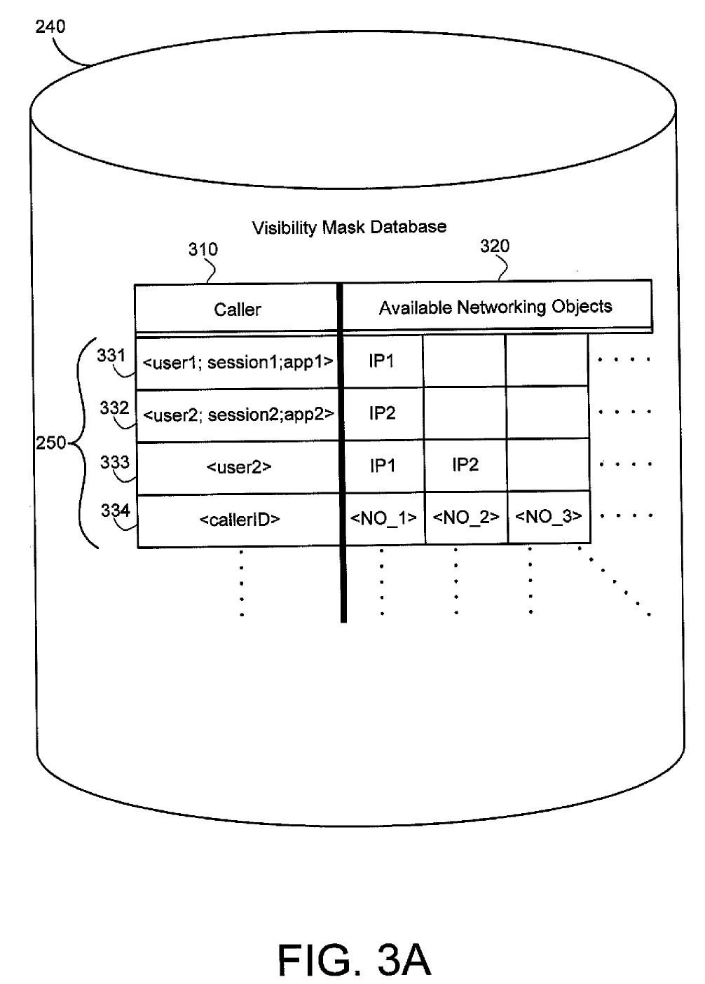

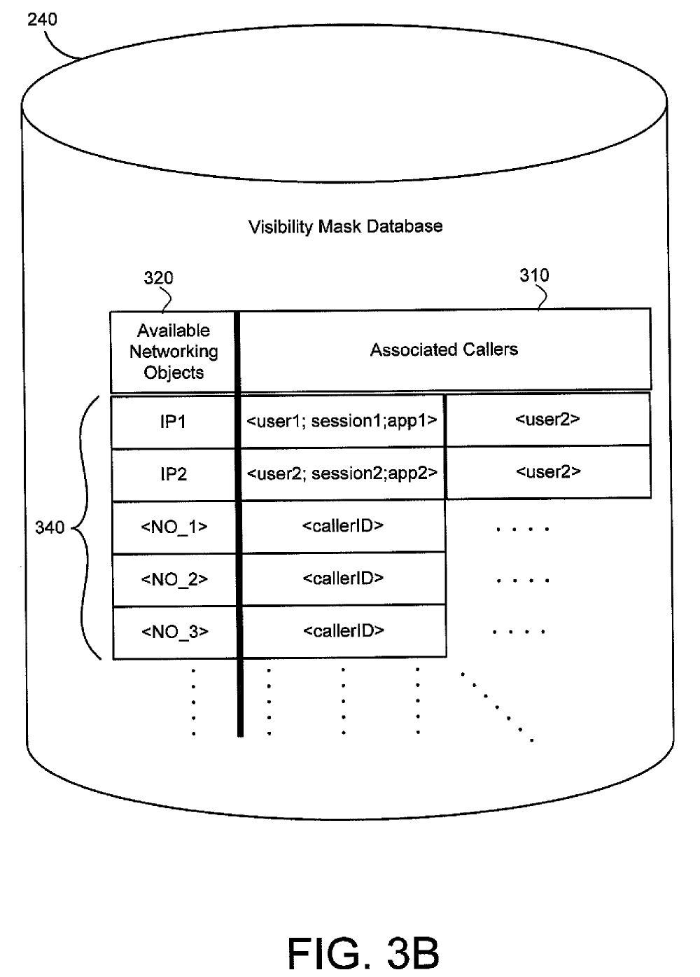

The visibility mask defines the networking objects which determine how, and if, the requested networking function is performed. Further description of an embodiment of a visibility mask database 240 and visibility masks 250 is provided with reference to FIG. 3.

A visibility mask may be any data structure, object, access control list (ACL), program or other construct that represents a caller's network view. In the described embodiments, a network view is represented based on networking objects. FIG. 3A illustrates an example embodiment of the visibility mask database 240 in which visibility masks associate a caller identified in column 310, with any number of networking objects identified in fields in column 320.

Rows 331-334 provide illustrative examples.

Generally, as shown in row 334, the caller field in column 310 indicates the caller name (<callerID>). Column 320 contains a suitable number of networking object fields used to identify the networking objects associated with the caller (<NO_1>, <NO_2>, <NO_3>, . . . ).

The caller may be identified in any suitable way. For example, in row 331 the caller is identified hierarchically by user (user1), session (session1) and application (app2). Similarly, row 332 associates a caller, <user2; session2; app2>. In row 333, a caller is simply identified by the user, <user2>.

The networking object fields of column 320 may identify networking objects associated with the corresponding caller in any suitable way. In row 331 the caller is associated with a networking object identified as “IP1” (e.g., an IP address). Similarly, in row 332 the caller is associated with a networking object identified as “IP2” (e.g., a different IP address). In row 333, the caller is associated with both networking objects identified as “IP1” and “IP2”.

This example illustrates several features that may be present in some embodiments. One such feature is that each caller may be associated with an arbitrary subset of networking objects. The subsets available to the callers may be overlapping. For example, FIG. 3A shows that IP1 is available to both <user1; session1; app1> and <user2>. Likewise, IP2 is available to both <user2; session2; app2> and <user2>. In this way, there is no requirement that each networking object be available to only one caller or to all callers.

FIG. 3A also illustrates that it is not necessary that all callers be identified in the same way or with the same granularity. For example, when a caller exists in a hierarchical structure, not all callers need have the same granularity (e.g., caller <user1; session1; app1> is at a “fine granularity” while caller <user2> is at a “coarse granularity”).

In some embodiments, when callers exist in a hierarchical structure, multiple visibility masks may be within the scope of a single caller (e.g., a caller <user2; session2; app2> falls within the scope of visibility masks for caller <user2> and <user2; session2; app2>). This initial ambiguity may be resolved in any suitable way, for example, by selecting for a caller the finest granularity of visibility masks available. Using this rule, in this example, a caller <user2; session2; app2>, uses the visibility mask so named while a caller, <user2; session2; app3>, uses the <user2> visibility mask.

Conversely in some other embodiments, if multiple visibility masks are applicable for a caller, the caller may be provided with access to all of the networking objects identified in any of the visibility masks. As another example, callers may be classified as privileged or unprivileged. Privileged callers may be given access to all of the networking objects available, regardless of what networking objects are identified for the caller. Any suitable resolution rules may be used to identify which visibility masks apply to a caller.

Other scenarios exist in which processing, in addition to reading a row from visibility mask database 240, may be used to identify networking objects available to a caller. A caller may have a redundancy of networking objects available (e.g., <user2> may use either of two IP addresses). A caller may request use of specific networking objects in performing a specific networking function or some other mechanism may be used to identify the specific networking objects used to respond to a request for a networking function.

Accordingly, any suitable processing may be used to relate the information in visibility mask database 240 to a network view available to a specific caller. In some embodiments, networking APIs 230 may be programmed to perform this processing. In other embodiments, interfaces to visibility mask database 240 may be programmed to perform this processing.

FIG. 3A also illustrates that networking objects may be within the network view of more than one caller. As shown, <user1; session1; app1> and <user2> both are associated with “IP1”. However, caller <user1; session1; app1> and <user2> do not share the same network view. While both callers have the networking object IP1 within their respective visibility masks, only <user2> has the networking object IP2 within its visibility mask. Although not shown in FIG. 3A, in some embodiments, callers may share a network view.

Alternative structures of visibility masks in the visibility mask database may also be used. In some embodiments, visibility masks may define by exclusion which networking objects an associated caller has access to. Masks may also be defined by default. For example, if no mask is defined for a caller, that caller may be given access to no networking objects or, in some embodiments, a defined set of default networking objects. Visibility masks may also define networking objects available to an associated caller through an executable function. For example, when the networking APIs request the caller's visibility mask, the functions may be executed to determine the available networking objects. In some embodiments, the visibility mask may assign networking objects both directly and through function calls. In yet some other embodiments, information identifying available networking objects may be organized by networking object rather than by caller as illustrated in FIG. 3. In such an embodiment, information may be stored for each available networking object, specifying the potentially multiple callers the networking object is available to.

As one example of an alternative implementation, a visibility mask may be an access control list (ACL) defining callers associated with a networking object. FIG. 3B illustrates visibility masks using access control lists 340. FIG. 3B illustrates an example embodiment of the visibility mask in which ACLs are stored as a table of available networking objects 320 and associated callers 310 that may access those objects. In some embodiments, ACLs associate a networking object with one or more callers whose network view includes the networking object. In such an embodiment, a caller's visibility mask includes the networking objects the caller is associated with by the ACLs. Though, any suitable structure of a visibility mask may be used. In the example, visibility mask databases 240 shown in FIG. 3A and FIG. 3B, the visibility masks are the same for both embodiments. In the former the information may be viewed as being organized by caller, and the later as being organized by networking object.

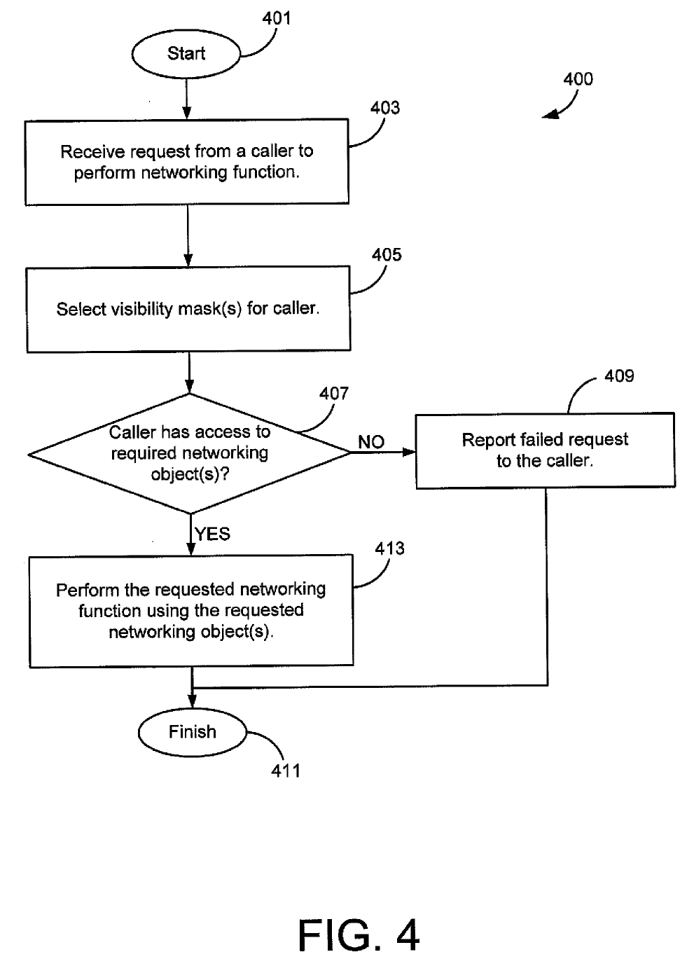

A method 400 of performing a networking function using a network view appropriate for a specific caller is described with reference to FIG. 4. In the example of FIG. 4, the request for the networking function includes an identification of one or more networking objects to be used in completing the networking function.

Method 400 begins at start 401. Initially, at step 403, a request from a caller is received to perform a networking function. In the case when the caller is a user, the request may be directly as a result of the user inputting a command. Though, the process of FIG. 4 could be invoked by an application being executed by the user executing a call to an operating system function that involves a networking operation.

Accordingly, a networking function may be any command that involves a networking object. The networking function may request a networking activity be performed using a specific networking object. For example, a networking function may be a request to send data to another device over network 120 using a specified IP address.

Regardless of the specific type of networking function, the request also conveys the identity of the caller, which may be used to determine the network view to be used in responding to the request. At step 405, one or more visibility masks are selected for the caller. A visibility mask associates networking objects with the caller. The visibility mask may be requested from the visibility mask database. In some embodiments, no visibility masks are associated with the caller. If so, a default visibility mask may be applied (e.g., with no networking objects assigned). In some other embodiments, multiple visibility masks may be selected and appropriate rules may be applied to determine which networking objects are available to the caller.

At step 407, a determination is made as to whether the caller has access to the required networking object(s). The determination may be made by comparing a required networking object(s) (e.g., specified by the request), to the available networking objects as defined by the visibility mask for the caller obtained in step 405.

If it is determined at step 407 that the caller does not have access to the required networking object, the caller's request fails and may be reported back to the caller at step 409. The method 400 finishes 411 after reporting the failed request.

If it is determined at step 407 that the caller does have access to the required networking object(s), the requested networking function is performed at step 413. For example, if the networking function requires interfacing with a network interface, the network interface may be controlled to perform the requested networking function using the requested networking object(s). After performance of the step 413, the method 400 finishes 411.

In the embodiment of method 400, networking functions are requested by a call to a networking API. Accordingly, steps 403, 405, 407, 409 and 413 may be performed within computer-executable modules that implement the API. After method 400 finishes 411, control and results of performing the networking function may be returned to the program calling the networking function.

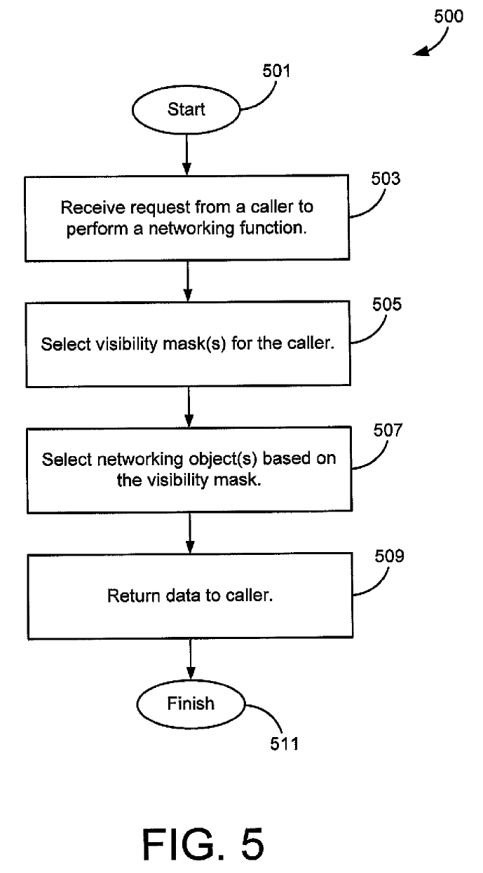

Turning now to FIG. 5, a method 500 of performing a networking function using a network view appropriate for a specific caller is described. As in the example of FIG. 4, steps 503, 505, 507 and 509 may be performed by an API called to implement a networking function, though the processing may be performed in any suitable component. However, in the example of FIG. 4, the networking function controlled a network interface to perform a networking function. In the example of FIG. 5, the networking function results in a return of information about a network interface. Though examples of two types of networking functions are provided by FIGS. 4 and 5, it should be appreciated that any suitable type of function may be performed.

In contrast to the example of FIG. 4 in which the visibility mask was used to validate whether requested networking objects identified in a call are available to a caller, in the example of FIG. 5, the request for the networking function does not include an identification of all networking objects to be used in completing the networking function. Rather, the component implementing the networking function selects appropriate networking objects based on the network view of the caller.

Method 500 begins at step 501 with a call to the API or other component to implement a networking function. As in steps 403 and 405 (FIG. 4), at step 503, a request from a caller is received to perform a networking function, and at step 505, one or more visibility masks are selected for the caller.

At step 507, networking objects are selected based on the visibility mask. For example, if the networking function requires an IP address to be completed, the IP address used in completing the function may be supplied from the visibility mask for the caller.

Regardless of which networking objects are selected, the networking objects may be used to perform the networking function requested by the caller. The networking objects may be selected in any suitable way from the visibility mask(s) to perform the networking function. For example, selection criteria may be defined to select networking objects when multiple redundant options are available. In some embodiments, the networking function may request specific networking objects to use.

In step 509, data generated by performing the networking function using the networking objects selected with the visibility mask is returned to the caller. In some instances, the networking function may be a request for information. In other instances, the data may provide an indication of performance of the networking function (e.g., success, failure). The data may indicate a status of the networking object. For example, the data may indicate the networking object is or is not available to the present caller based on the visibility mask. The data may indicate the networking object is currently in use by another caller. The method 500 may finish 511 after performance of step 509.

Though, in some embodiments, data at step 509 may be routed other than to the caller. For example, method 500 may be adapted to perform caller specific logging. Alternatively or additionally, method 400 may also be modified to perform caller specific logging. Though, caller specific logging may be implemented in any suitable way.

For example, a networking API may make an entry in an activity log when handling a caller's request to perform a networking function. The log entry, instead of or in addition to identifying the caller, may record any of the networking objects used by or accessible to that caller, as may be appropriate for a desired logging function. The caller specific log may provide a historical record of a caller's network related activities, such as the networking functions performed on the caller's behalf, their success or failure, and any other desirable information. Callers may be logged individually or hierarchically at any suitable level of granularity. For example, callers may be logged at the user level, with all subordinate callers (e.g., a session of the user) being logged to the corresponding user's log file.

Log activity may be analyzed, for example, for resource utilization tracking, to recognize bottlenecks, security breeches, and the like. The log may be used in any desired way, such as to reallocate network resources, for troubleshooting or to meet regulatory requirements in certain jurisdictions that require reporting of network utilization by user.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

It should be appreciated the application of network views need not be limited to components such as networking APIs 230 through which application programs directly access networking functions. Any component that provides users access to a network may be modified to access visibility masks to apply network views on a caller-by-caller basis.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable medium (or multiple computer readable media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a computer device having access to a network, the method comprising:
receiving, from a caller, a call to perform a networking function;
selecting a visibility mask based on an identity of the caller;
selecting a networking object for use in performing the network function based on the visibility mask; and
providing a response to the caller, the response being based at least in part on performing the networking function with the selected networking object.

2. The method of claim 1, wherein:
providing a response to the caller comprises indicating a status of the selected networking object.

3. The method of claim 1, wherein the networking function is a status request.

4. The method of claim 3, wherein providing a response to the caller comprises indicating to the caller the availability of the networking object.

5. The method of claim 1, wherein the networking object is an IP address.

6. The method of claim 1, wherein the caller is associated with a user account and selecting a visibility mask comprises selecting a visibility mask associated with the user account.

7. The method of claim 6, wherein the caller is a specific instance of an application.

8. The method of claim 1, wherein the networking function comprises transmitting data over the network, and the method further comprises:
transmitting the data over the network.

9. A computing device for managing access to a network having a plurality of networking objects, the device comprising:
a computer-storage medium configured to store a visibility mask database, the visibility mask database comprising a plurality of visibility masks, each visibility mask associated with a caller and each visibility mask defining a subset of the plurality of networking objects available to the caller; and
a processor configured to, in response to a call from a caller to perform a networking function, access the visibility mask database to determine an availability of a networking object to the caller based on the visibility mask associated with the caller and respond to the caller, the response being based at least in part on the networking function and the availability of the networking object,
wherein for at least two of the plurality of visibility masks, the defined subsets are different and include at least one common networking object.

10. The computing device of claim 9, wherein the call specifies the networking object for use in performing the networking function.

11. The computing device of claim 9, wherein the call does not specify the networking object for use in performing the networking function and the response is based at least in part on the networking function and a networking object selected from the visibility mask.

12. The computing device of claim 9, wherein the networking object is an IP address.

13. The computing device of claim 9, wherein the caller is associated with a user account.

14. The computing device of claim 9, wherein each of the plurality of visibility masks in the visibility mask database comprises a field identifying a caller and at least a field identifying a networking object accessible to the caller.

15. The computing device of claim 9, wherein:
the visibility mask database comprises a plurality of access control lists, each access control list being associated with a networking object of the plurality of networking objects, and
each of the plurality of visibility masks in the visibility mask database comprises a field identifying a caller in one or more of the plurality of access control lists.

16. A computer-storage medium comprising computer executable modules for execution on a computer having a plurality of callers and a plurality of networking objects, the modules comprising:
a masking programming interface configured to manage a visibility mask database having a plurality of visibility masks, each visibility mask associating a caller of the plurality of callers with a subset of the plurality of networking objects, the masking programming interface adapted to associate arbitrary subsets of the plurality of networking objects with each caller of the plurality of callers;
a networking programming interface configured to, when invoked by a caller of the plurality of callers, access a visibility mask from the visibility mask database, the visibility mask being associated with the caller, and respond to the caller based at least in part on a networking object of the plurality of networking objects identified in the visibility mask as available to the caller.

17. The computer-storage medium of claim 16, wherein the networking programming interface is adapted to select a networking object from the visibility mask associated with the caller and perform a networking function based on the selected networking object.

18. The computer-storage medium of claim 16, wherein the networking object is an IP address.

19. The computer-storage medium of claim 16, wherein the networking programming interface is a networking application programming interface (API) configured to control a network interface.

20. The computer-storage medium of claim 16, wherein the plurality of visibility masks comprise visibility masks defining overlapping subsets of the plurality of networking objects for at least a portion of the plurality of networking objects.
